(19) United States
(12) Patent Application Publication
(10) Pub. No.: US 2025/0156977 A1
(43) Pub. Date: May 15, 2025

(54) ELECTRONIC DEVICE FOR PROVIDING SIMILAR INCIDENT INFORMATION ABOUT REPORTED INCIDENT AND OPERATING METHOD OF ELECTRONIC DEVICE

(71) Applicant: Electronics and Telecommunications Research Institute, Daejeon (KR)

(72) Inventors: Jaehoon JEONG, Chungcheongnam-do (KR); Jimin LEE, Daejeon (KR); Hyunho PARK, Daejeon (KR); Sungwon BYON, Daejeon (KR); Eunjung KWON, Sejong-si (KR); Minjung LEE, Daejeon (KR); Youngsoo PARK, Daejeon (KR); Eui-Suk JUNG, Daejeon (KR)

(73) Assignee: Electronics and Telecommunications Research Institute, Daejeon (KR)

(21) Appl. No.: 18/946,329

(22) Filed: Nov. 13, 2024

(30) Foreign Application Priority Data
Nov. 14, 2023 (KR) 10-2023-0157461

(51) Int. Cl. G06Q 50/26; G06F 16/35; G06V 30/19

(52) U.S. Cl. CPC G06Q 50/26; G06F 16/35; G06V 30/19093

(57) ABSTRACT

Provided are an electronic device for providing similar incident information about a reported incident and an operating method of the electronic device, in which the operating method includes receiving new incident information and reporter information about a reported new incident, determining whether the new incident information is obtained by a false or mistaken report, based on the new incident information and the reporter information, determining, when the new incident information is determined to be true, a similarity with one or more pieces of related incident information associated with the reported new incident in a database that stores past incident information, and outputting, among the one or more pieces of related incident information, similar incident information to respond to the reported new incident, based on the similarity.

### CROSS-REFERENCE TO RELATED APPLICATIONS

This application claims the benefit of Korean Patent Application No. 10-2023-0157461, filed on Nov. 14, 2023, in the Korean Intellectual Property Office, the entire disclosure of which is incorporated herein by reference for all purposes.

### BACKGROUND

### 1. Field of the Invention

One or more embodiments relate to an electronic device for providing similar incident information about a reported incident and an operating method of the electronic device.

### 2. Description of the Related Art

Recently, as crimes, such as stabbing rampages, and reported incidents and accidents increase, research is being conducted to provide an appropriate on-site response measure or decision-making measure to an on-site manager, such as a police officer, based on reported incident information. An on-site manager may respond to a reported new incident by referring to pieces of past similar incident information in a database to find an appropriate on-site response measure. A technique for determining the similarity between pieces of text is to measure the similarity between two or more documents, sentences, or words and may be used in various natural language processing fields.

### SUMMARY

A report of an incident (e.g., a 112 report, etc.) may depend on the subjective perspective and judgment of a reporter, which may differ from information about an actual incident. In addition, when a reported incident is obtained by a false or mistaken report, significant manpower or property loss may occur to handle the reported incident. An on-site manager may not be able to handle an incident in a timely manner due to a time delay in finding an on-site response measure, based on the report content of a new incident, and may inappropriately handle the incident due to failure to find an appropriate on-site response measure.

Embodiments may determine whether new incident information is obtained by a false or a mistaken report, based on new incident information and reporter information about a reported new incident.

Embodiments may determine the similarity with one or more pieces of related incident information associated with a new incident in a database and provide similar incident information to respond to the new incident, based on the similarity.

Embodiments may provide, based on regulation information associated with laws, systems, or guidelines to respond to a reported new incident, on-site response information changed according to the regulation information.

Other objects and advantages of the present disclosure can be understood by the following description and will become more apparent by the embodiments of the present disclosure. In addition, it will be apparent that the objects and advantages of the present disclosure can be readily realized by the means and combinations thereof recited in the claims.

According to an aspect, there is provided an operating method of an electronic device including receiving new incident information and reporter information about a reported new incident, determining whether the new incident information is obtained by a false or mistaken report, based on the new incident information and the reporter information, determining, when the new incident information is determined to be true, a similarity with one or more pieces of related incident information associated with the reported new incident in a database that stores past incident information, and outputting, among the one or more pieces of related incident information, similar incident information to respond to the reported new incident, based on the similarity.

The determining of the similarity may include selecting the one or more pieces of related incident information, based on the new incident information, and determining the similarity by comparing text of the new incident information with text of the one or more pieces of related incident information.

The determining of the similarity may include selecting the one or more pieces of related incident information using incident classification, report date and time, and a report location of the new incident information and determining the similarity using a text similarity algorithm.

The determining of whether the new incident information is obtained by the false or mistaken report may include determining whether the new incident information is obtained by the false or mistaken report using a judgment weight based on the past incident information in the database.

The determining of whether the new incident information is obtained by the false or mistaken report may include determining a probability of whether the new incident information is obtained by the false or mistaken report, based on text of the new incident information, using a binary classification deep learning model that trains the past incident information, and determining whether the new incident information is obtained by the false or mistaken report, based on the judgment weight and the probability of whether the new incident information is obtained by the false or mistaken report.

The outputting of the similar incident information may further include, based on regulation information associated with laws, systems, or guidelines to respond to the reported new incident, outputting on-site response information changed according to the regulation information.

The outputting of the similar incident information may further include outputting textual on-site response information to respond to the reported new incident, based on the new incident information and the similar incident information.

The operating method may further include storing the new incident information in the database by preprocessing the new incident information.

The operating method may further include storing on-site processing information for the new incident information and the reported new incident that is processed in the database by preprocessing the on-site processing information for the new incident information and the reported new incident that is processed when the new incident information is determined to be true and storing the new incident information in the database by preprocessing the new incident information when the new incident information is determined to be not true.

The new incident information may include text information and unusual-thing information associated with a reporting situation of the reported new incident, in which the text information may include incident classification of the reported new incident and content of the reported new incident.

According to another aspect, there is provided an electronic device including a processor, in which the processor is configured to receive new incident information and reporter information about a reported new incident, determine whether the new incident information is obtained by a false or mistaken report, based on the new incident information and the reporter information, determine, when the new incident information is determined to be true, a similarity with one or more pieces of related incident information associated with the reported new incident in a database that stores past incident information, and output, among the one or more pieces of related incident information, similar incident information to respond to the reported new incident, based on the similarity.

The processor may be configured to select the one or more pieces of related incident information, based on the new incident information, and determine the similarity by comparing text of the new incident information with text of the one or more pieces of related incident information.

The processor may be configured to select the one or more pieces of related incident information using incident classification, report date and time, and a report location of the new incident information and determine the similarity using a text similarity algorithm.

The processor may be configured to determine whether the new incident information is obtained by the false or mistaken report using a judgment weight based on the past incident information in the database.

The processor may be configured to determine a probability of whether the new incident information is obtained by the false or mistaken report, based on text of the new incident information, using a binary classification deep learning model that trains the past incident information, and determine whether the new incident information is obtained by the false or mistaken report, based on the judgment weight and the probability of whether the new incident information is obtained by the false or mistaken report.

The processor may be configured to further output, based on regulation information associated with laws, systems, or guidelines to respond to the reported new incident, on-site response information changed according to the regulation information.

The processor may be configured to further output textual on-site response information to respond to the reported new incident, based on the new incident information and the similar incident information.

The processor may be configured to store the new incident information in the database by preprocessing the new incident information.

The processor may be configured to store, in the database, on-site processing information for the new incident information and the reported new incident that is processed by preprocessing the on-site processing information for the new incident information and the reported new incident that is processed when the new incident information is determined to be true and store the new incident information in the database by preprocessing the new incident information when the new incident information is determined to be not true.

The new incident information may include text information and unusual-thing information associated with a reporting situation of the reported new incident, in which the text information may include incident classification of the reported new incident and content of the reported new incident.

Additional aspects of embodiments will be set forth in part in the description which follows and, in part, will be apparent from the description, or may be learned by practice of the disclosure.

Embodiments may help manage human resources or resources efficiently and assist in the handling of an incident by determining whether a reported new incident is obtained by a false or mistaken report.

Embodiments may help an on-site manager, such as a police officer, to find an appropriate on-site response measure by providing similar incident information, based on the similarity with pieces of related incident information.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a structure of an electronic device that provides similar incident information about a reported new incident, according to an embodiment;

FIG. 2 is a diagram illustrating preprocessing new incident information, according to an embodiment;

FIG. 3 is a diagram illustrating a database that stores past incident information, according to an embodiment;

FIG. 4 is a diagram illustrating determining whether new incident information is obtained by a false or mistaken report, according to an embodiment;

FIG. 5 is a diagram illustrating determining the similarity with one or more pieces of related incident information associated with a new incident, according to an embodiment;

FIG. 6 is a diagram illustrating outputting similar incident information to respond to a new incident, according to an embodiment;

FIG. 7 is a diagram illustrating datafication of new incident information and storing on-site response information, according to an embodiment;

FIG. 8 is a schematic flowchart illustrating an electronic device that provides similar incident information about a reported incident, according to an embodiment; and

FIG. 9 is a schematic block diagram illustrating an electronic device that provides similar incident information about a reported incident, according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

As used herein, “A or B”, “at least one of A and B”, “at least one of A or B”, “A, B or C”, “at least one of A, B and C”, “at least one of A, B, or C”, and “one or a combination of at least two of A, B, and C,” each of which may include any one of the items listed together in the corresponding one of the phrases, or all possible combinations thereof. Although terms, such as first, second, and the like are used to describe various components, the components are not limited to the terms. These terms should be used only to distinguish one component from another component. For example, a first component may be referred to as a second component, or similarly, the second component may be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, embodiments will be described in detail with reference to the accompanying drawings. When describing the embodiments with reference to the accompanying drawings, like reference numerals refer to like elements and a repeated description related thereto will be omitted.

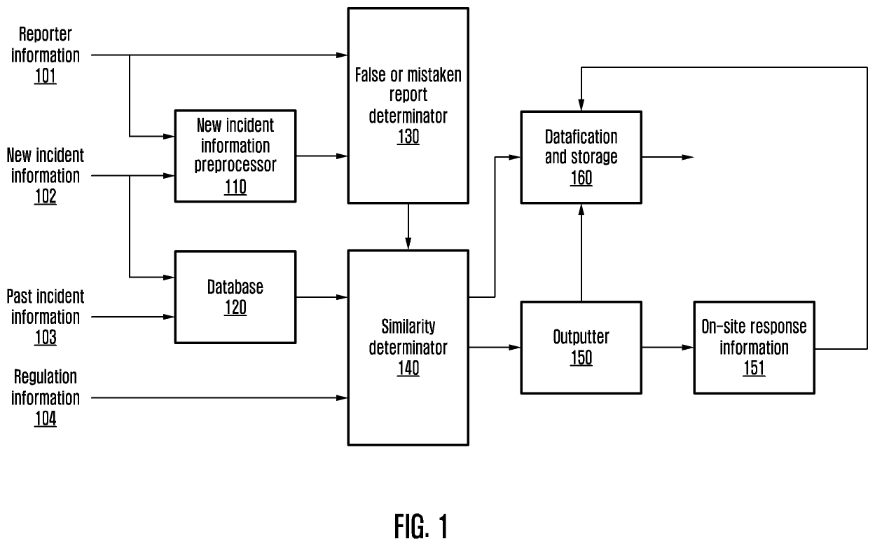

FIG. 1 is a diagram illustrating a structure of an electronic device that provides similar incident information about a reported new incident, according to an embodiment.

FIG. 1 illustrates an example of the structure of the electronic device including a new incident information preprocessor 110, a database 120, a false or mistaken report determinator 130, a similarity determinator 140, an outputter 150, and a datafication and storage 160 to provide the similar incident information about the reported new incident.

According to an embodiment, the electronic device may provide the similar incident information about the reported new incident using reporter information 101, new incident information 102, past incident information 103, and regulation information 104. The reporter information 101 may be information associated with a reporter of the reported new incident. The reporter information 101 may include information about a report history and action record of the reporter, whether a device such as a universal subscriber identity module (USIM), etc., exists, whether a public telephone is used, or an actual location of the reporter. The new incident information 102 may be information about the reported new incident. The new incident information 102 may include information about the urgency or risk, the report date and time, the report location, the report content of the reported new incident, or the classification of a received incident. When the report of the new incident is made by voice such as a phone call, the new incident information 102 may also include information about the report voice. The past incident information 103 may be information about an incident that was processed in the past. The past incident information 103 may include information about the urgency or risk, the report date and time, the report location, the report content of a past incident, or the incident classification and information about an on-site processing record, closed incident code, closed action classification, or closed action center classification. The regulation information 104 may be information associated with laws, systems, or guidelines required to handle an incident. The regulation information 104 may include information about law revision information, new legislation information, internal guidelines, or processing manuals.

The new incident information preprocessor 110 may identify characteristic information, and variabalize and preprocess the characteristic information, based on the reporter information 101 corresponding to metadata and the new incident information 102 based on information received by a report.

The database 120 may filter one or more pieces of related incident information associated with the reported new incident, based on the new incident information 102 and the past incident information 103 that is stored.

The false or mistaken report determinator 130 may determine whether the reported new incident is obtained by a false or mistaken report, based on the reporter information 101 and preprocessed new incident information.

Based on the new incident information 102 including information about whether the reported new incident is a false or mistaken report, which is output from the false or mistaken report determinator 130, the filtered one or more pieces of related incident information, and the regulation information 104 to reflect changes in the regulation of on-site processing, the similarity determinator 140 may calculate the similarity between the one or more pieces of related incident information and the new incident information 102 when the reported new incident is determined to be a general report, not a false or mistaken report, and may output the similar incident information based on the similarity. When the regulation information 104 associated with laws, systems, or guidelines to respond to the new incident is changed, the similarity determinator 140 may further output on-site response information changed according to the regulation information 104. When it is suspected that the new incident is obtained by a false or mistaken report, the similarity determinator 140 may transmit, to the datafication and storage 160, the new incident information 102 as false or mistaken report information.

The outputter 150 may generate result text by textualizing a prompt, based on the on-site response information reflecting the similar incident information and the regulation information 104. The outputter 150 may transmit, to the datafication and storage 160, the new incident information 102 as general report incident information.

The datafication and storage 160 may preprocess the new incident information 102 classified into the false or mistaken report information or the general report and store the new incident information 102 in the database 120. In addition, in the case of general report incident information, the datafication and storage 160 may also preprocess on-site response information 151 about the on-site response content of the new incident and store the on-site response information 151 in the database 120. For reinforcement and feedback of the system that provides the similar incident information about a reported incident, the datafication and storage 160 may store feedback information about the structure, running, and operation of a system, in the database 120 or a separate database that is different from the database 120.

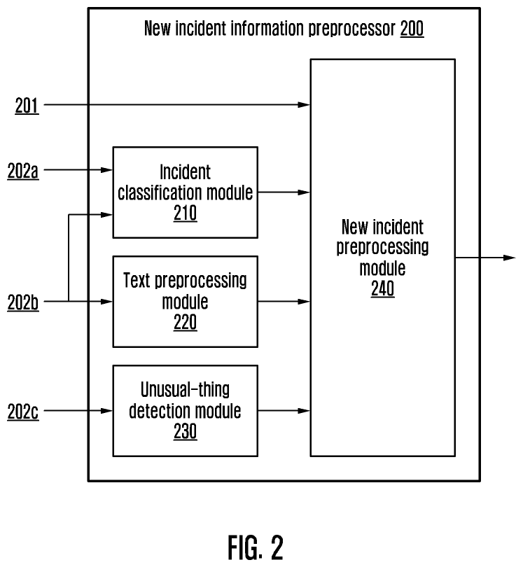

In FIG. 1, although the new incident information preprocessor 110, the database 120, the false or mistaken report determinator 130, the similarity determinator 140, the outputter 150, and the datafication and storage 160 are illustrated as components or devices forming the electronic device for description, embodiments are not limited thereto, and each component may be implemented by an operation of a processor or the like. An operation of each component is described in detail below with reference to FIGS. 2 to 7.

FIG. 2 is a diagram illustrating preprocessing new incident information, according to an embodiment.

FIG. 2 illustrates an example of a structure of a new incident information preprocessor 200 including an incident classification module 210, a text preprocessing module 220, an unusual-thing detection module 230, and a new incident preprocessing module 240.

Information 201 may represent the reporter information described above, and pieces of partial information 202a, 202b, and 202c may represent pieces of partial information about the new incident information described above. The partial information 202a may include information about the urgency or risk, the report date and time, and the report location of a reported new incident or the classification of a received incident. The partial information 202b may include information (e.g., text that summarizes the content of the received report, etc.) about the report content of the reported new incident. The partial information 202c may include information about the report voice of the reported new incident.

The incident classification module 210 may reverify the incident classification received for the new incident by comparing the report content with a classification item, based on the partial information 202a and the partial information 202b, and may generate and output information about the incident classification. The incident classification module 210 may use a nominal variable, etc., to classify the report content.

The text preprocessing module 220 may perform preprocessing so that the partial information 202b that is input may be processed by subsequent modules. For example, the text of the report content received from the 112 situation room, etc., may require preprocessing because the content of the incident is compressed and summarized, and there are many repetitive expressions, separators, special characters, or personal information (e.g., the address, phone number, name, etc.). The text preprocessing module 220 may normalize frequently appearing quotation-type endings in the text and remove special characters. The text preprocessing module 220 may not perform processing on stop words because the text of the report content is data that implicitly represents the content of the new incident. The text preprocessing module 220 may tokenize the text of the report content for subsequent operations. The text preprocessing module 220 may use a pre-trained Korean-based language model, such as KoBERT or KoGPT, as a tokenization model to tokenize the text. The text preprocessing module 220 may assign an input_id to tokenized data, complete the preprocessing of the text by performing sequence padding, and output text preprocessing information of the report content by combining the input text with the input_id vector.

The unusual-thing detection module 230 may detect an unusual thing of a report using the report voice of the reported new incident of the partial information 202c. The unusual-thing detection module 230 may detect, as the unusual thing, surrounding noise in the report voice, the unusual thing of a reporter (e.g., suspected drunken state, rambling, speech breakdown, etc.), or the unusual thing in a call (e.g., screaming, a call being hung up, etc.). The unusual-thing detection module 230 may convert and store the detected unusual thing into dummy variables for convenience of datafication and operation. The unusual-thing detection module 230 may use a voice feature extraction technique, such as a Mel-frequency cepstral coefficient (MFCC) or perceptual linear prediction (PLP), to build a voice processing and analysis artificial intelligence (AI) model. In addition, the unusual-thing detection module 230 may implement functions, such as drunken state identification, speech breakdown identification, etc., and unusual-thing detection functions using a voice model such as Wave2Vec, Speech Transformer, etc. The unusual-thing detection module 230 may output and store information about the detected unusual thing as unusual-thing information.

The new incident preprocessing module 240 may integrate pieces of preprocessed data for the reported new incident using the information 201, information output from the incident classification module 210, information output from the text preprocessing module 220, and information output from the unusual-thing detection module 230. The new incident preprocessing module 240 may perform conversion on the pieces of preprocessed data to have a format of a predetermined type for subsequent operations and generate and output preprocessed new incident information. The preprocessed new incident information may include other pieces of information, in addition to metadata related to the report, detailed information about the incident content, and an unusual thing in the text and voice of the preprocessed report content.

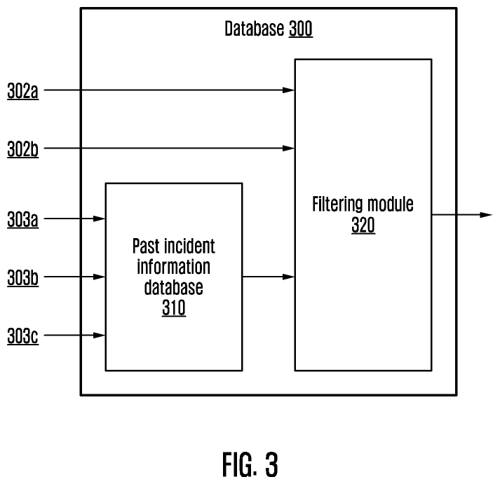

FIG. 3 is a diagram illustrating a database that stores past incident information, according to an embodiment.

FIG. 3 illustrates an example of a structure of a database 300 including a past incident information database 310 and a filtering module 320.

Pieces of partial information 302a and 302b may represent pieces of partial information about new incident information. The partial information 302a may include information about the urgency or risk, the report date and time, the report location of a reported new incident, or the classification of a received incident. The partial information 302b may include information about the report content of the reported new incident.

Pieces of partial information 303a, 303b, and 303c may represent pieces of partial information about past incident information. The partial information 303a may include information about an on-site response record, closed incident code, closed action classification, or closed action center classification related to the closure of a past incident. The partial information 303b may include information related to the content of the past incident. The partial information 303c may include information about the urgency or risk, the report date and time, the report location of the past incident, or the classification of the received incident.

The past incident information database 310 may store and manage the partial information 303a, the partial information 303b, and the partial information 303c about input past incident information. The past incident information database 310 may store information, for example, as shown in Table 1 below, and output the information if needed.

TABLE 1

| | | | | | Content | Content | Report | |
|---|---|---|---|---|---|---|---|---|
| | Type of | | | Type of | of | of | Date | |
| | Received | Type of | Details of | Closed | Received | On-Site | and | Report |
| Code | Incident | Closure | Closure | Incident | Report | Response | Time | Location |
| C1 | Domestic | On-Site | On-Site | Domestic | My | Domestic | 2023.01 . . . | Omitted |
| | Violence | Closure | Action | Violence | husband | violence | | |
| | | | | | hits . . . | current . . . | | |
| C0 | Other | Under | Transfer | Other | [CODE | Special | 2023.02 . . . | Omitted |
| | Criminal | Constant | to Other | Criminal | 0 . . . | injury | | |
| | Laws | Investigation | Departments | Laws | | related . . . | | |
| C2 | Amusement | False and | False | Amusement | Students | Everyone | 2023.01 . . . | Omitted |
| | Activities | Mistaking | | Activities | are | is an | | |
| | Affecting | | | Affecting | drinking . . . | adult . . . | | |
| | Public | | | Public | | | | |
| | Morals | | | Morals | | | | |
| C2 | Dating | On-Site | On-Site | Dating | A man | There | 2023.03 . . . | Omitted |
| | Abuse | Closure | Action | Abuse | hits a | is a bit | | |
| | | | | | woman . . . | of a | | |
| | | | | | | quarrel . . . | | |
| C3 | Acquisition | Non- | Same | Acquisition | I have | Lost | | |
| | of Lost | Dispatch | | of Lost | acquired a | property is | 2023.04 . . . | Omitted |
| | Property | Closure | | Property | shopping | received . . . | | |
| | | | | | bag . . . | | | |
| C1 | Traffic | Uncompleted | Not | Traffic | Suspected | Not | 2023.06 . . . | Omitted |
| | Violation | | Found | Violation | of | found . . . | | |
| | | | | | drunk | | | |
| | | | | | driving . . . | | | |

Table 1 is an example illustrating a structure in which the past incident information database 310 stores information, and embodiments are not limited thereto.

The filtering module 320 may filter one or more pieces of related incident information associated with the reported new incident using information output from the past incident information database 310, the partial information 302a, and the partial information 302b. The filtering module 320 may output the filtered one or more pieces of related incident information.

The one or more pieces of related incident information may include information about reception information, closure information, or reported content of the related incident.

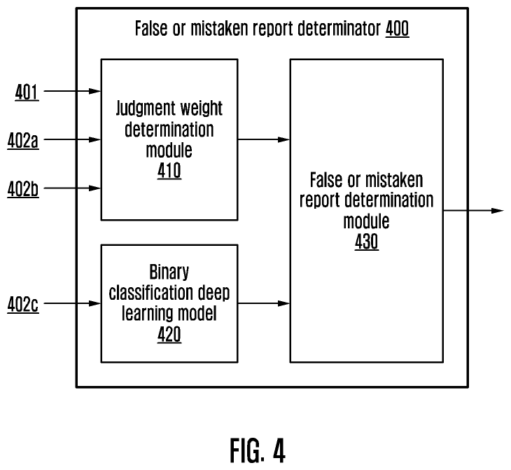

FIG. 4 is a diagram illustrating determining whether new incident information is obtained by a false or mistaken report, according to an embodiment.

FIG. 4 illustrates an example of a structure of a false or mistaken report determinator 400 including a judgment weight determination module 410, a binary classification deep learning model 420, and a false or mistaken report determination module 430.

The false or mistaken report determinator 400 may determine whether reported new incident information is obtained by a false or mistaken report, based on new incident information and reporter information.

Pieces of partial information 402a, 402b, and 402c may be pieces of partial information about preprocessed new incident information. The partial information 402a may include unusual-thing information. The partial information 402b may include metadata related to the report of the new incident and detailed information about the incident content. The partial information 402c may include text preprocessing information of the report content.

The judgment weight determination module 410 may generate and output a judgment weight to determine whether the reported new incident information is obtained by a false or mistaken report, based on reporter information 401, the partial information 402a, and the partial information 402b. Pieces of information used by the judgment weight determination module 410 may include pieces of information other than text. The judgment weight determination module 410 may set the judgment weight as a value that is greater than or equal to 0 and less than or equal to 1. The judgment weight determination module 410 may set the judgment weight based on statistics of past incident information in a database. The closer the judgment weight is to 1, the higher the probability that the new incident information is obtained by a false or mistaken report.

For example, the judgment weight determination module 410 may set the judgment weight, as shown in Equation 1 below.

$$Y = {W}_{1} {X}_{1} + {W}_{2} {X}_{2} + {W}_{3} {X}_{3} + {W}_{4} {X}_{4} + {W}_{5} {X}_{5} + {W}_{6} {X}_{6} \qquad [ Equation 1 ]$$

Here, Y denotes a judgment weight to determine whether a reported new incident is obtained by a false or mistaken report through pieces of information other than text, X₁ to X₆ denote pieces of information to determine whether the reported new incident is obtained by a false or mistaken report, and W₁ to W₆ denote weights for each piece of information. For example, X₁ to X₆ may each have values of 1 and 0, according to whether a reporter has a false or mistaken report in the past, whether a device, such as a USIM, etc., is absent, whether a public telephone is used, whether a distance between a location of the reporter and a spot of the incident exceeds a predetermined reference, whether there is an unusual thing in the voice, and whether punishment is to be notified in case of a false report. W₁ to W₆ may be determined using logistic regression based on pieces of past incident information. In Equation 1, although only 6 numbers of pieces of information and weights are used for description, embodiments are not limited thereto and may be one or more numbers.

The binary classification deep learning model 420 may calculate the probability of whether the reported new incident is obtained by a false or mistaken report using the partial information 402c including text information. The binary classification deep learning model 420 may be a language model that receives pre-tokenized and embedded text as an input. For example, KoBERT, etc., may be used as a pre-trained language model, in addition to a generative language model such as Kopca, KoGPT, etc., which is a model specialized for Korean. The binary classification deep learning model 420 may be capable of training and verifying a language model by training text based on pieces of information stored in the database. The binary classification deep learning model 420 may calculate the probability of whether the new incident information is obtained by a false or mistaken report through a trained model. In addition, the binary classification deep learning model 420 may primarily determine that the new incident information is obtained by a false or mistaken report when the probability exceeds a preset numerical value. For example, the binary classification deep learning model 420 may output a SoftMax function as a result using the received text information and calculate the probability that the new incident information is obtained by a false or mistaken report, based on the SoftMax score for the SoftMax function. The binary classification deep learning model 420 may transmit, to the false or mistaken report determination module 430, the SoftMax score and whether the output new incident information is obtained by a false or mistaken report.

For example, the binary classification deep learning model 420 may receive the report content text, such as “Samseong Station on Line No. 2”, “Reporter suspected of being drunk”, “He/she said he or she has a wanted criminal”, “Punishment is noticed in case of a false report”, or “Please check the reporter's report history” and calculate the SoftMax score as 0.89, based on the text. When the predetermined numerical value is set to 0.50, since the SoftMax score exceeds the predetermined numerical value, the binary classification deep learning model 420 may output the SoftMax score of 0.89 together with information that a false or mistaken report is suspected.

The false or mistaken report determination module 430 may receive the judgment weight output from the judgment weight determination module 410 and the probability indicating whether the reported new incident is obtained by a false or mistaken report and finally determine whether the reported new incident is obtained by a false or mistaken report. The false or mistaken report determination module 430 may calculate the false or mistaken report score using the received pieces of information and determine that the reported new incident is obtained by a false or mistaken report when the false or mistaken report score exceeds a predetermined reference. The predetermined reference may be determined by an on-site manager, a policy maker, or a system operator (e.g., a National Police Agency, etc.). The false or mistaken report determination module 430 may output the new incident information together with whether the new incident is a false or mistaken report and the false or mistaken report score, regardless of whether it is determined that the new incident information is obtained by a false or mistaken report.

For example, the false or mistaken report determination module 430 may finally determine whether the reported new incident is obtained by a false or mistaken report, as shown in Equation 2 below.

$$Z = {W}_{1} {X}_{1} + {W}_{2} {X}_{2} + {W}_{3} {X}_{3} + {W}_{4} {X}_{4} + {W}_{5} {X}_{5} + {W}_{6} {X}_{6} + {W}_{7} {X}_{7} + {W}_{S} {X}_{S} \qquad [ Equation 2 ]$$

Here, Z denotes a false or mistaken report score, X₁ to X₈ denote pieces of information to determine whether the reported new incident is obtained by a false or mistaken report, and W₁ to W₃ denote weights for each piece of information. For example, X₁ to X₆ may each be the same as the value of Equation 1, and X₇ and X₃ denote a value indicating, as 1 and 0, whether a false or mistaken report, which is output from the binary classification deep learning model 420, is suspected, and the SoftMax score, respectively. As shown in Equation 2, W₁ to W₈ may be determined using logistic regression based on pieces of past incident information. The false or mistaken report determination module 430 may adjust an input value in forward propagation for the pieces of past incident information, determine loss with binary cross entropy (BEC), and establish a model by adjusting the gradient based on the loss. In Equation 2, although only 8 numbers of pieces of information and weights are used for description, embodiments are not limited thereto and may be one or more numbers.

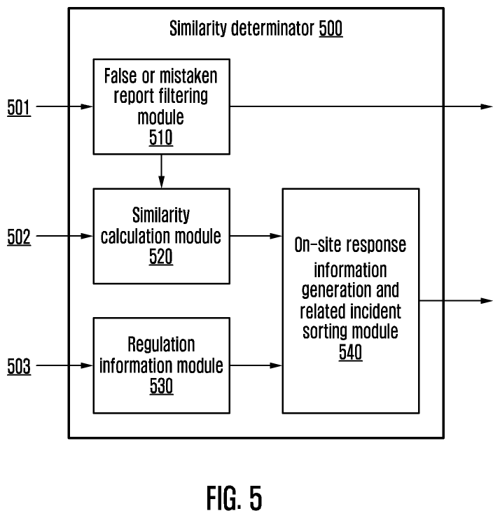

FIG. 5 is a diagram illustrating determining the similarity with one or more pieces of related incident information associated with a new incident, according to an embodiment.

FIG. 5 illustrates an example of a structure of a similarity determinator 500 including a false or mistaken report filtering module 510, a similarity calculation module 520, a regulation information module 530, and an on-site response information generation and related incident sorting module 540.

The similarity determinator 500 may filter new incident information 501 when it is determined that the new incident information 501 is obtained by a false or mistaken report and may calculate the similarity with one or more pieces of related incident information 502 when the new incident information 501 is determined to be true rather than being obtained by a false or mistaken report.

The new incident information 501 may be output from the false or mistaken report determinator 400 and may include information about whether the new incident information 501 is obtained by a false or mistaken report together with information about a reported new incident. The one or more pieces of related incident information 502 may be output from the database 300 and may include information about one or more of related incidents associated with a new incident.

The false or mistaken report filtering module 510 may generate false or mistaken report reception information based on the new incident information 501 when the new incident information 501 is obtained by a false or mistaken report. The generated false or mistaken report reception information may be transmitted to a datafication and storage for storage and management. The false or mistaken report filtering module 510 may generate general report incident information based on the new incident information 501 when the new incident information 501 is determined to be a general report rather than a false or mistaken report. The generated general report incident information may be transmitted to the similarity calculation module 520 to calculate the similarity with the one or more pieces of related incident information 502.

The similarity calculation module 520 may calculate the similarity of each piece of related incident information using the one or more pieces of related incident information 502 filtered from pieces of past incident information and the general report incident information transmitted from the false or mistaken report filtering module 510. The similarity calculation module 520 may generate similarity information by combining the general report incident information, the one or more pieces of related incident information 502, and the calculated similarity. The similarity calculation module 520 may use an embedding-based similarity measurement method, such as Siamese Network, in addition to a similarity measure, such as Cosine or Jaccard, to calculate the similarity between pieces of text.

The regulation information module 530 may generate changed on-site response information using regulation information 503 including information about laws or systems and internal guidelines (e.g., internal guidelines related to a 112 report response, etc.). The regulation information module 530 may appropriately respond to acts that were not crimes in the past but become crimes due to the establishment or revision of laws and subordinate statutes, etc. In addition, the regulation information module 530 may provide the content of the changed internal guidelines and the changed on-site response measure when an appropriate on-site response measure is changed due to the establishment or revision of the internal guidelines, etc. For example, when a certain substance was not classified as a narcotic in the past but is classified as a narcotic under the revised current law, a response measure, such as a simple guidance measure that was performed in the past for a report related to a certain substance, is inappropriate, and accordingly, the regulation information module 530 may provide the content of the changed law and the changed on-site response measure related to the certain substance.

The on-site response information generation and related incident sorting module 540 may sort the one or more pieces of related incident information 502 according to the similarity using similarity information transmitted from the similarity calculation module 520 and pieces of information transmitted from the regulation information module 530 and may output pieces of information about an incident having a high similarity. The pieces of information about the incident having a high similarity may include the incident content, metadata, and on-site response information of each incident. The on-site response information generation and related incident sorting module 540 may review matters related to the on-site response measure for the pieces of information about the incident having a high similarity. The on-site response information generation and related incident sorting module 540 may output, based on the pieces of information transmitted from the regulation information module 530, information about the content of the changed laws and the changed on-site response measure together when the response measure of a new incident must be different from the past response measure.

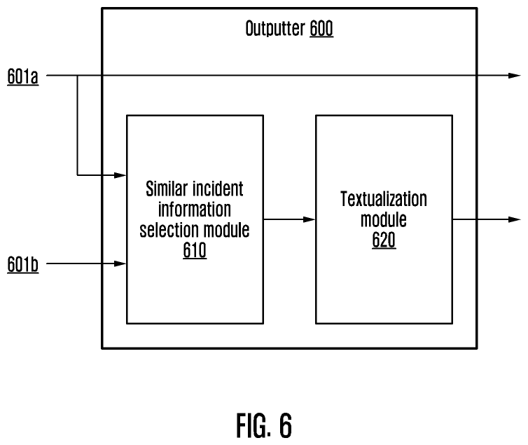

FIG. 6 is a diagram illustrating outputting similar incident information to respond to a new incident, according to an embodiment.

FIG. 6 illustrates an example of a structure of an outputter 600 including a similar incident information selection module 610 and a textualization module 620.

The outputter 600 may select similar incident information from among one or more pieces of related incident information using pieces of information output from an on-site response information generation and related incident sorting module and may textualize and output the similar incident information.

Pieces of partial information 601a and 601b may be pieces of partial information about pieces of information output from a similarity determinator. The partial information 601a may include information about report-related metadata, incident content, and unusual thing to be stored as general report incident information. The partial information 601b may include information about an incident having a high similarity among the one or more pieces of related incident information and information about the content of the changed laws and changed on-site response measure.

The similar incident information selection module 610 may select a predetermined number of pieces of similar incident information from among pieces of related incident information sorted according to the similarity, based on the partial information 601a and the partial information 601b. The similar incident information selection module 610 may select pieces of similar incident information in order of a high similarity among one or more pieces of related incident information. The similar incident information selection module 610 may output, as a similar incident prompt, the selected pieces of similar incident information, information about response measure information, and the changed on-site response measure for each incident. The similar incident prompt may include information about a reported new incident, pieces of related incident information determined to be similar to the new incident, and on-site response information changed according to regulation information.

The textualization module 620 may convert an input similar incident prompt into result text to be output for an on-site manager (e.g., an on-site police officer, etc.). The textualization module 620 may use generative AI based on a large-scale language model. Since pieces of information about an incident may include pieces of personal sensitive information regardless of new incidents and past incidents, the textualization module 620 may use a model that is available for a local environment. A model used for the prompt textualization may be determined by a system operator (e.g., a National Police Agency, etc.). The result text may be generated in the process of receiving a report and issuing an order and may be transmitted to the terminals of each of on-site managers who receive the order such that the situational understanding, decision-making, and appropriate on-site response may be supported for a new incident.

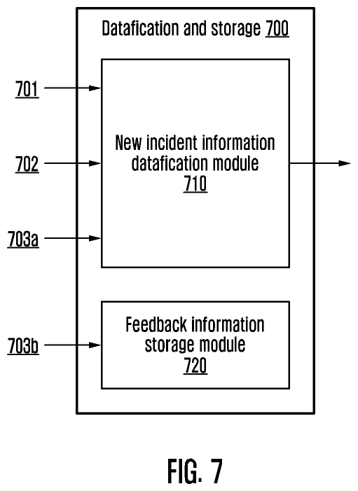

FIG. 7 is a diagram illustrating datafication of new incident information and storing on-site response information, according to an embodiment.

FIG. 7 illustrates an example of a structure of a datafication and storage 700 including a new incident information datafication module 710 and a feedback information storage module 720.

The datafication and storage 700 may preprocess general report incident information 701, false or mistaken report incident information 702, and new incident processing information 703a for a reported new incident and store the general report incident information 701, the false or mistaken report incident information 702, and the new incident processing information 703a in a database. The datafication and storage 700 may store, in the database or a separate database, feedback information 703b about a structure, running, and operation of a system. The new incident processing information 703a and the feedback information 703b may be pieces of partial information of on-site response information about the on-site response content of a new incident.

The new incident information datafication module 710 may receive the general report incident information 701 when it is determined that the new incident is obtained by a general report rather than a false or mistaken report and may receive the false or mistaken report incident information 702 when it is determined that the new incident is obtained by a false or mistaken report. In addition, the new incident information datafication module 710 may receive the new incident processing information 703a, which is information input from a field after completing the on-site response measure for the new incident. The new incident information datafication module 710 may aggregate the pieces of received information, preprocess the pieces of information according to the structure of the database, and store the pieces of information. For example, as shown in Table 1, the new incident information datafication module 710 may preprocess and store the pieces of information in the form of urgency or risk, report date and time, report location, received incident classification, incident content, on-site response information, closed incident code, closed measure classification, and sub-classification according to the structure of the database.

The feedback information storage module 720 may store, in the database or the separate database, the feedback information 703b of an on-site manager dispatched to the field, to manage the feedback information 703b. The feedback information 703b may include feedback about the operation or structure of the entire system in addition to feedback about the determination of whether a false or mistaken report is provided to an on-site manager, filtering of related incident information, similar incident selection, or on-site response measure text. The system operator may store and use the feedback information 703b to maintain and improve the system.

In FIGS. 2 to 7, although each module is illustrated as a module or component for description, embodiments are not limited thereto, and each configuration may be implemented by the operation of a processor or the like.

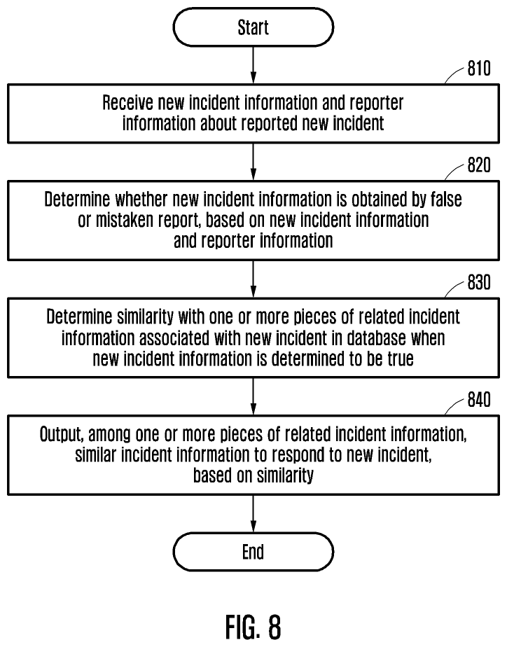

FIG. 8 is a schematic flowchart illustrating an electronic device that provides similar incident information about a reported incident, according to an embodiment.

In the following embodiments, operations may be performed sequentially but not necessarily. For example, the order of the operations may be changed and at least two of the operations may be performed in parallel. Operations 810 to 840 may be performed by at least one component (e.g., a processor) of an electronic device.

In operation 810, the electronic device may receive new incident information and reporter information about a reported new incident.

In operation 820, the electronic device may determine whether the new incident information is obtained by a false or mistaken report, based on the new incident information and the reporter information. The electronic device may determine whether the new incident information is obtained by a false or mistaken report using a judgment weight, based on past incident information in a database. The electronic device may use a binary classification deep learning model that trains the past incident information, determine the probability of whether the new incident information is obtained by a false or mistaken report, based on text of the new incident information, and determine whether the new incident information is obtained by a false or mistaken report, based on the judgment weight and the probability of whether the new incident information is obtained by a false or mistaken report.

In operation 830, when the new incident information is determined to be true, the electronic device may determine the similarity with one or more pieces of related incident information associated with a new incident in the database that stores the past incident information. The electronic device may select the one or more pieces of related incident information, based on the new incident information, and determine the similarity by comparing the text of the new incident information with text of the one or more pieces of related incident information. The electronic device may select the one or more pieces of related incident information using the incident classification, report date and time, and report location of the new incident information and may determine the similarity using a text similarity algorithm.

In operation 840, the electronic device may output, among the one or more pieces of related incident information, similar incident information to respond to the new incident, based on the similarity. The electronic device may further output, based on regulation information associated with laws, systems, or guidelines to respond to the new incident, on-site response information changed according to the regulation information. The electronic device may further output textual on-site response information to respond to the new incident, based on the new incident information and the similar incident information.

The electronic device may preprocess the new incident information and store the new incident information in the database. When the new incident information is determined to be true, the electronic device may preprocess the new incident information and on-site processing information for a processed new incident and may store, in the database, the new incident information and the on-site processing information for the processed new incident. When the new incident information is determined to be not true, the electronic device may preprocess the new incident information and store the new incident information in the database.

The new incident information may include text information including the incident classification of the new incident and the content of the new incident and unusual-thing information related to a reporting situation of the new incident.

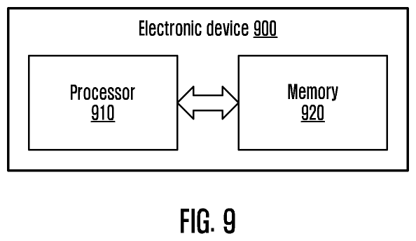

FIG. 9 is a schematic block diagram illustrating an electronic device that provides similar incident information about a reported incident, according to an embodiment.

Referring to FIG. 9, an electronic device 900 may include a processor 910. The processor 910 may include at least one processor. In addition, the electronic device 900 may further include a memory 920.

The memory 920 may store instructions (e.g., programs) executable by the processor 910. For example, the instructions may include instructions for performing an operation of the processor 910 and/or an operation of each component of the processor 910.

The processor 910 may be a device that executes instructions or programs or controls the electronic device 900 and may include, for example, various processors such as a central processing unit (CPU) and a graphics processing unit (GPU). The processor 910 may receive new incident information and reporter information about a reported new incident. The processor 910 may determine whether the new incident information is obtained by a false or mistaken report, based on the new incident information and the reporter information. When the new incident information is determined to be true, the processor 910 may determine the similarity with one or more pieces of related incident information associated with a new incident in a database that stores past incident information. The processor 910 may output, among the one or more pieces of related incident information, similar incident information to respond to the new incident, based on the similarity.

The processor 910 may select the one or more pieces of related incident information, based on the new incident information, and determine the similarity by comparing text of the new incident information with text of the one or more pieces of related incident information. The processor 910 may select the one or more pieces of related incident information using the incident classification, report date and time, and report location of the new incident information and may determine the similarity using a text similarity algorithm. The processor 910 may determine whether the new incident information is obtained by a false or mistaken report using a judgment weight based on the past incident information in the database. The processor 910 may use a binary classification deep learning model that trains the past incident information, determine the probability of whether the new incident information is obtained by a false or mistaken report, based on the text of the new incident information, and determine whether the new incident information is obtained by a false or mistaken report, based on the judgment weight and the probability of whether the new incident information is obtained by a false or mistaken report. The processor 910 may further output, based on regulation information associated with laws, systems, or guidelines to respond to the new incident, on-site response information changed according to the regulation information. The processor 910 may further output textual on-site response information to respond to the new incident, based on the new incident information and the similar incident information. The processor 910 may preprocess the new incident information and store the new incident information in the database. When the new incident information is determined to be true, the processor 910 may preprocess the new incident information and on-site processing information for a processed new incident and may store, in the database, the new incident information and the on-site processing information for the processed new incident. When the new incident information is determined to be not true, the processor 910 may preprocess the new incident information and store the new incident information in the database.

The new incident information may include text information including the incident classification of the new incident and the content of the new incident and unusual-thing information related to a reporting situation of the new incident.

In addition, the electronic device 900 may process the operations described above.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Accordingly, other implementations are within the scope of the following claims.

What is claimed is:

1. An operating method of an electronic device, the operating method comprising:
receiving new incident information and reporter information about a reported new incident;
determining whether the new incident information is obtained by a false or mistaken report, based on the new incident information and the reporter information;
determining, when the new incident information is determined to be true, a similarity with one or more pieces of related incident information associated with the reported new incident in a database that stores past incident information; and
outputting, among the one or more pieces of related incident information, similar incident information to respond to the reported new incident, based on the similarity.

2. The operating method of claim 1, wherein the determining of the similarity comprises:
selecting the one or more pieces of related incident information, based on the new incident information; and
determining the similarity by comparing text of the new incident information with text of the one or more pieces of related incident information.

3. The operating method of claim 1, wherein the determining of the similarity comprises:
selecting the one or more pieces of related incident information using incident classification, report date and time, and a report location of the new incident information; and
determining the similarity using a text similarity algorithm.

4. The operating method of claim 1, wherein the determining of whether the new incident information is obtained by the false or mistaken report comprises determining whether the new incident information is obtained by the false or mistaken report using a judgment weight based on the past incident information in the database.

5. The operating method of claim 4, wherein the determining of whether the new incident information is obtained by the false or mistaken report comprises:
determining a probability of whether the new incident information is obtained by the false or mistaken report, based on text of the new incident information, using a binary classification deep learning model that trains the past incident information; and
determining whether the new incident information is obtained by the false or mistaken report, based on the judgment weight and the probability of whether the new incident information is obtained by the false or mistaken report.

6. The operating method of claim 1, wherein the outputting of the similar incident information further comprises, based on regulation information associated with laws, systems, or guidelines to respond to the reported new incident, outputting on-site response information changed according to the regulation information.

7. The operating method of claim 1, wherein the outputting of the similar incident information further comprises outputting textual on-site response information to respond to the reported new incident, based on the new incident information and the similar incident information.

8. The operating method of claim 1, further comprising:
storing the new incident information in the database by preprocessing the new incident information.

9. The operating method of claim 1, further comprising:
storing on-site processing information for the new incident information and the reported new incident that is processed in the database by preprocessing the on-site processing information for the new incident information and the reported new incident that is processed when the new incident information is determined to be true; and
storing the new incident information in the database by preprocessing the new incident information when the new incident information is determined to be not true.

10. The operating method of claim 1, wherein the new incident information comprises text information and unusual-thing information associated with a reporting situation of the reported new incident, wherein the text information comprises incident classification of the reported new incident and content of the reported new incident.

11. An electronic device comprising:
a processor,
wherein the processor is configured to:
receive new incident information and reporter information about a reported new incident;
determine whether the new incident information is obtained by a false or mistaken report, based on the new incident information and the reporter information;
determine, when the new incident information is determined to be true, a similarity with one or more pieces of related incident information associated with the reported new incident in a database that stores past incident information; and
output, among the one or more pieces of related incident information, similar incident information to respond to the reported new incident, based on the similarity.

12. The electronic device of claim 11, wherein the processor is configured to:
select the one or more pieces of related incident information, based on the new incident information; and
determine the similarity by comparing text of the new incident information with text of the one or more pieces of related incident information.

13. The electronic device of claim 11, wherein the processor is configured to:
select the one or more pieces of related incident information using incident classification, report date and time, and a report location of the new incident information; and
determine the similarity using a text similarity algorithm.

14. The electronic device of claim 11, wherein the processor is configured to determine whether the new incident information is obtained by the false or mistaken report using a judgment weight based on the past incident information in the database.

15. The electronic device of claim 14, wherein the processor is configured to:
determine a probability of whether the new incident information is obtained by the false or mistaken report, based on text of the new incident information, using a binary classification deep learning model that trains the past incident information; and
determine whether the new incident information is obtained by the false or mistaken report, based on the judgment weight and the probability of whether the new incident information is obtained by the false or mistaken report.

16. The electronic device of claim 11, wherein the processor is configured to further output, based on regulation information associated with laws, systems, or guidelines to respond to the reported new incident, on-site response information changed according to the regulation information.

17. The electronic device of claim 11, wherein the processor is configured to further output textual on-site response information to respond to the reported new incident, based on the new incident information and the similar incident information.

18. The electronic device of claim 11, wherein the processor is configured to store the new incident information in the database by preprocessing the new incident information.

19. The electronic device of claim 11, wherein the processor is configured to:
store, in the database, on-site processing information for the new incident information and the reported new incident that is processed by preprocessing the on-site processing information for the new incident information and the reported new incident that is processed when the new incident information is determined to be true; and
store the new incident information in the database by preprocessing the new incident information when the new incident information is determined to be not true.

20. The electronic device of claim 11, wherein the new incident information comprises text information and unusual-thing information associated with a reporting situation of the reported new incident, wherein the text information comprises incident classification of the reported new incident and content of the reported new incident.
